(19) United States
(12) Patent Application Publication
(10) Pub. No.: US 2013/0175204 A1
(43) Pub. Date: Jul. 11, 2013

(54) METHOD FOR REDUCING CATALYST FINES IN SLURRY OIL FROM A FLUIDIZED CATALYST CRACKING PROCESS

(71) Applicant: BAKER HUGHES INCORPORATED, Houston, TX (US)

(72) Inventor: Micheal McElhinney, Liverpool (GB)

(73) Assignee: BAKER HUGHES INCORPORATED, HOUSTON, TX (US)

(21) Appl. No.: 13/735,557

(22) Filed: Jan. 7, 2013

Related U.S. Application Data
(60) Provisional application No. 61/584,574, filed on Jan. 9, 2012.

(51) Int. Cl. C08L 61/14

(52) U.S. Cl. CPC C08L 61/14
USPC 208/291; 525/472; 524/541

(57) ABSTRACT

A composition useful for reducing catalyst fines in an FCC slurry oil from a fluid catalytic cracking process is disclosed wherein the composition comprises a first resin which is an nonyl-phenol formaldehyde resin that has been ethoxylated and a second resin which is a p-t-amyl-phenol formaldehyde resin that has been ethoxylated.

### BACKGROUND OF THE INVENTION

1. Field of the Invention

The invention relates to additives useful for reducing catalyst fines in slurry oil from a fluid catalytic cracking process.

2. Background of the Art

Fluid catalytic cracking (FCC) is a process that cracks heavy gas oils into diesel oils, gasoline, and other hydrocarbon components by employing catalysts that speed up the cracking reaction. The catalysts employed may have an ultimate particle size on the order of about 20-120 microns. These catalysts are typically zeolites.

It is often desirable to remove or recover as much of the catalysts as is possible from the slurry oil exiting an FCC process. The catalyst particles that fall outside of the 20-120 microns range can be particularly problematic. For example, the particles that are smaller than 20 microns, hereinafter referred to as “fines” can be a problem in use of the cracked products. Those particles having a particle size of from about 0.2 to about 1.0 microns may be particularly troublesome and can cause substantial increases in the stack opacity of units utilizing products having such fines. For example, increasing the stack opacity can be problematic in meeting environmental regulations. It would be desirable in the art to reduce the amount of fines in FCC slurry oil.

### SUMMARY OF THE INVENTION

In one aspect, the invention is a composition useful for reducing catalyst fines in a slurry oil from a fluid catalytic cracking process comprising a first resin which is an nonyl-phenol formaldehyde resin that has been ethoxylated and a second resin which is a p-t-amyl-phenol formaldehyde resin that has been ethoxylated.

In another aspect, the invention is a composition comprising slurry oil and a first resin which is a nonyl-phenol formaldehyde resin that has been ethoxylated and a second resin which is a p-t-amyl-phenol formaldehyde resin that has been ethoxylated.

In still another aspect, the invention is a method for reducing catalyst fines in a slurry oil from a fluid catalytic cracking process comprising treating the slurry oil exiting fluid catalytic cracking process with a settling aid comprising a first resin which is an nonylphenol formaldehyde resin that has been ethoxylated and a second resin which is an p-t-amyl-phenol formaldehyde resin that has been ethoxylated.

### DESCRIPTION OF THE PREFERRED EMBODIMENTS

In the practice of the method of the disclosure, an FCC slurry oil is treated with a settling aid. For the purposes of this application, an FCC process is one employing a zeolite catalyst to crack heavy hydrocarbons. Such processes are well known to those of ordinary skill in the art. The slurry oil treated herewith is that leaving the reactor after the temperature has been lowered to a point sufficient to avoid decomposition of the resins used to prepare the settling additive.

The amount of additives required to be effective may vary as a function of the properties of the FCC slurry oil. Generally though, the amount of additive necessary in the FCC slurry oil will be from about 150 ppm to about 2000 ppm.

The additives useful with the method of the application include those having two resins present. The first resin is a nonyl-phenol formaldehyde resin that has been ethoxylated. The first resins are prepared using a weight ratio of nonyl phenol to formaldehyde of from about 8.5:1 to about 7.5:1. The ratio of resin to ethylene oxide is from about 1.7:1 to about 1.9:1.

The second resin is a p-t-amyl-phenol formaldehyde resin that has been ethoxylated. This resin is prepared at a weight ratio of p-t-amyl-phenol to formaldehyde of from about 5.6:1 to about 5.5:1. The ratio of resin to ethylene oxide is from about 2.2:1 to about 2.1:1.

The settling agent of the application may be prepared wherein the ratio between the first resin and the second resin is from about 1:9 to about 9:1.

The resins useful with the method of the application may be prepared using any method known to those of ordinary skill in the art of preparing phenol-formaldehyde resins. For example, the ethoxylation of the resins may be performed using a sodium or potassium oxide as a catalyst. The resins themselves may be prepared by employing methods such as that disclosed in U.S. Pat. No. 4,814,094 the content of which is incorporated herein in its entirety. Any method known to be useful to those of ordinary skill in the art in preparing such resin and in the ethoxylation thereof may be used with the method of the application.

### EXAMPLES

The following example is provided to illustrate the invention. The example is not intended to limit the scope of the invention and it should not be so interpreted. Amounts are in weight parts or weight percentages unless otherwise indicated.

### Example 1 and Comparative Example A

A sample of FCC slurry oil having no settling aid is tested by allowing the slurry oil to sit unmolested and an aliquot of oil is then removed from the top of the sample and tested for ash content as a blank. A series of samples are then tested using a settling aid comprising a first resin which is a nonyl-phenol formaldehyde resin that has been ethoxylated and a second resin which is an p-t-amyl-phenol formaldehyde resin that has been ethoxylated and a second conventional settling aid which is an ammonium C₈-C₁₀ alkyl ether sulphate. At a concentration of 600 ppm, the efficiency of the settling aid was about 75%. In marked contrast, the conventional settling aid had an efficiency of about 40% at that same concentration.

What is claimed is:

1. A composition useful for reducing catalyst fines in a slurry oil from a fluid catalytic cracking process comprising a first resin which is a nonyl-phenol formaldehyde resin that has been ethoxylated and a second resin which is a p-t-amyl-phenol formaldehyde resin that has been ethoxylated.

2. The composition of claim 1 wherein the first resin is prepared using a weight ratio of nonyl phenol to formaldehyde of from about 8.5:1 to about 7.5:1.

3. The composition of claim 2 wherein the ratio of a nonyl-phenol formaldehyde resin to ethylene oxide is from about 1.7:1 to about 1.9:1.

4. The composition of claim 1 wherein the second resin is prepared at a weight ratio of p-t-amyl-phenol to formaldehyde of from about 5.6:1 to about 5.5:1.

5. The composition of claim 4 wherein the ratio of p-t-amyl-phenol formaldehyde resin to ethylene oxide is from about 2.2:1 to about 2.1:1.

6. A composition comprising FCC slurry oil and a first resin which is a nonyl-phenol formaldehyde resin that has been ethoxylated and a second resin which is a p-t-amyl-phenol formaldehyde resin that has been ethoxylated.

7. The composition of claim 6 wherein Generally the amount of additive present in the FCC slurry oil is from about 150 ppm to about 2000 ppm.

8. A method for reducing catalyst fines in FCC slurry oil comprising treating the FCC slurry oil exiting a fluid catalytic cracking process with a settling aid comprising a first resin which is an nonylphenol formaldehyde resin that has been ethoxylated and a second resin which is an p-t-amyl-phenol formaldehyde resin that has been ethoxylated.

9. The method of claim 8 wherein the first resin is prepared using a weight ratio of nonyl phenol to formaldehyde of from about 8.5:1 to about 7.5:1.

10. The method of claim 9 wherein the ratio of a nonyl-phenol formaldehyde resin to ethylene oxide is from about 1.7:1 to about 1.9:1.

11. The method of claim 8 wherein the second resin is prepared at a weight ratio of p-t-amyl-phenol to formaldehyde of from about 5.6:1 to about 5.5:1.

12. The method of Claim 11 wherein the ratio of p-t-amyl-phenol formaldehyde resin to ethylene oxide is from about 2.2:1 to about 2.1:1.
